(19) United States
(12) Patent Application Publication
(10) Pub. No.: US 2025/0145869 A1
(43) Pub. Date: May 8, 2025

(54) ADHESIVE FILM, OPTICAL MEMBER, AND OPTICAL DISPLAY APPARATUS

(71) Applicant: SAMSUNG SDI CO., LTD., Yongin-si (KR)

(72) Inventors: Ji Yeon KIM, Suwon-si (KR); Dong Myeong SHIN, Yongin-si (KR); Ji Ho KIM, Yongin-si (KR); Se Mi HEO, Suwon-si (KR); Jun Ki OH, Yongin-si (KR); Tae Mi KIM, Yongin-si (KR); Ji Young HAN, Yongin-si (KR); Il Jin KIM, Yongin-si (KR)

(21) Appl. No.: 18/938,558

(22) Filed: Nov. 6, 2024

(30) Foreign Application Priority Data
Nov. 6, 2023 (KR) 10-2023-0152132

(51) Int. Cl. C09J 7/38; B32B 7/12; B32B 15/082; B32B 15/18; B32B 27/08; B32B 27/16; B32B 27/30; B32B 27/36

(52) U.S. Cl. CPC C09J 7/385; B32B 7/12; B32B 15/082; B32B 15/18; B32B 27/08; B32B 27/16; B32B 27/308; B32B 27/36; B32B 2307/54; B32B 2307/542; B32B 2307/748; B32B 2457/20; C09J 2203/326; C09J 2301/414

(57) ABSTRACT

Disclosed herein are an adhesive film for a non-metal base material and a metal base material, an optical member including the adhesive film, and an optical display apparatus including the adhesive film. The adhesive film is a cured product of a composition including (meth)acrylic binder and a thermal curing agent. The adhesive film has a peel strength at 60° C. and 93% relative humidity of 400 gf/inch or more with respect to each of the non-metal base material and the metal base material. T. The (meth)acrylic binder is formed from a monomer mixture including 1 wt % to 10 wt % of a cycloaliphatic group-containing (meth)acrylic monomer.

### CROSS-REFERENCE TO RELATED APPLICATION

The present application claims priority and the benefit of Korean Patent Application No. 10-2023-0152132, filed on Nov. 6, 2023, in the Korean Intellectual Property Office, the entire disclosure of which is incorporated herein by reference.

### FIELD

The present disclosure relates to an adhesive film, an optical member including the adhesive film, and an optical display apparatus including the adhesive film.

### DESCRIPTION OF THE RELATED ART

In general, adhesive films are used to attach optical devices of an optical display apparatus to one another. Recently, with increasing interest in foldable optical display apparatuses, an adhesive film used in such an optical display apparatus is required to have good foldability.

An optical device may have layers including the same material or different materials. For example, the optical device may have a layer of a polymer or may have a layer of a metal. Thus, an adhesive film may be used to attach the polymer layer to the metal layer. In order to provide good foldability, the adhesive film should have good peel strength with respect to each of the metal layer and the polymer layer. In addition, the adhesive film should have good durability to be used in an optical display apparatus. There is therefore a need for an adhesive film that has good peel strength with respect to both a polymer layer and a metal layer under high temperature conditions and high temperature and high humidity conditions.

A background technique of the present disclosure is disclosed in Japanese Patent Laid-open Publication No. 2020-111734.

### SUMMARY OF THE DISCLOSURE

It is one aspect of the present disclosure to provide an adhesive film that has high peel strength with respect to both a non-metal base material and a metal base material under high temperature conditions and under high temperature and high humidity conditions and such that the adhesive film can ensure good foldability of a stacked structure of the non-metal base material, the adhesive film, and the metal base material under high temperature and high humidity conditions.

It is another aspect of the present disclosure to provide an optical member having a stacked structure of a non-metal base material, an adhesive film, and a metal base material, wherein the stacked structure has good reliability and foldability under high temperature conditions and under high temperature and high humidity conditions.

In accordance with one aspect of the present disclosure, there is provided an adhesive film for a non-metal base material and a metal base material. The adhesive film is a cured product of a composition including (meth)acrylic binder and a thermal curing agent. The adhesive film has a peel strength at 60° C. and 93% RH of 400 gf/inch or more with respect to each of the non-metal base material and the metal base material, wherein the (meth)acrylic binder is formed from a monomer mixture comprising 1 wt % to 10 wt % of a cycloaliphatic group-containing (meth)acrylic monomer.

In accordance with another aspect of the present disclosure, there is provided an optical member. The optical member includes a non-metal base material, an adhesive film, and a metal base material stacked, wherein the adhesive film adheres the non-metal base material to the metal base material, wherein the adhesive film includes a cured product of a composition including a (meth)acrylic binder and a thermal curing agent, and the (meth)acrylic binder is formed from a monomer mixture including 1 wt % to 10 wt % of a cycloaliphatic group-containing (meth)acrylic monomer.

In accordance with a further aspect of the present disclosure, there is provided an optical display apparatus. The optical display apparatus includes the adhesive film described above or the optical member described above.

Embodiments of the present disclosure provide an adhesive film that has high peel strength with respect to both a non-metal base material and a metal base material under high temperature conditions and under high temperature and high humidity conditions. The adhesive film can ensure good foldability of a stacked structure of the non-metal base material, the adhesive film, and the metal base material under high temperature and high humidity conditions.

Embodiments of the present disclosure provide an optical member having a stacked structure of a non-metal base material, an adhesive film, and a metal base material, wherein the stack structure has good reliability and foldability under high temperature conditions and under high temperature and high humidity conditions.

### BRIEF DESCRIPTION OF DRAWINGS

FIG. 1 is a graph depicting changes in peel strength of an adhesive film according to one embodiment with respect to a non-metal base material under high temperature conditions and under high temperature and high humidity conditions as a function of the content of a cycloaliphatic group-containing (meth)acrylic monomer in a monomer mixture.

FIG. 2 is a graph depicting changes in peel strength of the adhesive film with respect to a metal base material under high temperature conditions and under high temperature and high humidity conditions as a function of the content of the cycloaliphatic group-containing (meth)acrylic monomer in the monomer mixture.

FIG. 3 is a cross-sectional view of an optical member according to one embodiment.

FIG. 4 shows shear strain measurement results of an adhesive film according to one embodiment.

### DETAILED DESCRIPTION

Hereinafter, embodiments of the present disclosure will be described in detail with reference to the accompanying drawings. It should be understood that the present disclosure is not limited to the following embodiments and may be embodied in different ways, and that the embodiments are provided for complete disclosure and thorough understanding of the present disclosure by those skilled in the art.

The terminology used herein is for the purpose of describing exemplary embodiments and is not intended to limit the present disclosure. As used herein, the singular forms “a”, “an”, and “the” are intended to include the plural forms as well, unless the context clearly indicates otherwise.

Herein, “homopolymer glass transition temperature” may refer to a glass transition temperature (Tg) measured on a homopolymer of a target monomer using a differential scanning calorimeter (Discovery, TA Instruments Inc.). Specifically, the homopolymer of the target monomer is heated to 180° C. at a heating rate of 20° C./min, cooled gradually to 100° C., and heated to 100° C. at a heating rate of 10° C./min to obtain data on an endothermic transition curve, followed by determining the glass transition temperature by an inflection point of the endothermic transition curve.

Herein, “glass transition temperature” of a (meth)acrylic binder may be measured by a method known in the art using a differential scanning calorimeter (DSC).

Herein, “(meth)acryl” refers to acryl and/or methacryl.

Herein, “weight average molecular weight” may be a value obtained based on polystyrene conversion in gel permeation chromatography (GPC).

Herein, “shear strain” is a value measured at 60° C. and refers to the degree of deformation under a constant shear force. Referring to FIG. 4, values of strain on an adhesive film under a constant force are measured as a function of time under the conditions in an experimental example described below. A strain at a time of 600 seconds is defined as shear strain.

As used herein to represent a specific numerical range, the expression “X to Y” means “greater than or equal to X and less than or equal to Y (X≤ and ≤Y)”.

In accordance with one aspect of the present disclosure, there is provided an adhesive film that has high peel strength with respect to both a non-metal base material and a metal base material under high temperature conditions and under high temperature and high humidity conditions and can ensure good foldability of a stack structure of the non-metal base material, the adhesive film, and the metal base material.

Herein, “non-metal base material” may refer to a non-metal base material that forms (or is included in) an optical device of an optical display apparatus. Specifically, the non-metal base material may be a polymer film such as a polyester film including polyethylene terephthalate (PET) and the like, a cyclic olefin polymer film, a polycarbonate film, a (meth)acrylic film, a cellulose ester film, and the like. Preferably, the non-metal base material is a polyester polymer film, such as polyethylene terephthalate (PET).

Herein, “metal base material” may refer to a metal base material that forms (or is included in) an optical element of an optical display apparatus. Specifically, the metal base material may be a layer formed of a typical metal, such as an alkali metal, an alkaline earth metal, and the like. In measurement of peel strength, the metal base material may be represented by a steel use stainless (SUS) metal plate.

Herein, “peel strength under high temperature conditions” may refer to a peel strength measured at 60° C. Herein, “peel strength under high temperature and high humidity conditions” may refer to a peel strength measured at 60° C. and 93% relative humidity (RH). While not particularly restricted, “peel strength under high temperature conditions” is measured in a constant temperature chamber at 60° C., and, thus, a relative humidity in measurement of peel strength under high temperature conditions may be significantly low compared to that in measurement of peel strength under high temperature and high humidity conditions.

The adhesive film may be used to adhere the non-metal base material and the metal base material, and the adhesive film may be adhesively bonded to both the non-metal base material and the metal base material.

The adhesive film may have a peel strength of 400 gf/inch or more with respect to the non-metal base material under high temperature conditions and under high temperature and high humidity conditions. For example, the adhesive film may have a peel strength of 400 gf/inch to 1,000 gf/inch, specifically 500 gf/inch to 800 gf/inch, with respect to the non-metal base material under high temperature conditions and under high temperature and high humidity conditions. Within these ranges, the adhesive film can provide good foldability under repeated folding/unfolding.

The adhesive film also may have a peel strength of 400 gf/inch or more with respect to the metal base material under high temperature conditions and under high temperature and high humidity conditions. Conventional adhesive films exhibit lower peel strength with respect to the metal base material than with respect to the non-metal base material. The adhesive film according to the present disclosure has high peel strength with respect to not only the non-metal base material but also with respect to the metal base material. For example, the adhesive film may have a peel strength of 400 gf/inch to 1,000 gf/inch, more specifically 500 gf/inch to 800 gf/inch, with respect to the metal base material under high temperature conditions and under high temperature and high humidity conditions. Within these ranges of peel strength, the adhesive film can provide good foldability for repeated folding/unfolding.

s calculated according to Equation 1, the adhesive film may have a value of 1 or more, for example, 1 to 1.5, specifically greater than 1 and less than or equal to 1.5. Within these ranges, the adhesive film can be stably attached to the non-metal base material under high temperature and high humidity conditions while having enhanced adhesion to the non-metal base material.

### Equation 1: A2/A1

where A1 is a peel strength (unit: gf/inch) of the adhesive film with respect to the non-metal base material at 60° C., and A2 is a peel strength (unit: gf/inch) of the adhesive film with respect to the non-metal base material at 60° C. and 93% RH.

As calculated according to Equation 2, the adhesive film may have a value of 1 or more, for example, 1 to 1.5, specifically greater than 1 and less than or equal to 1.5. Within this range, the adhesive film can have enhanced adhesion to the metal base material.

### Equation 2: B1/B2

where B1 is a peel strength (unit: gf/inch) of the adhesive film with respect to the metal base material at 60° C., and B2 is a peel strength (unit: gf/inch) of the adhesive film with respect to the metal base material at 60° C. and 93% RH.

The adhesive film may have a shear strain at 60° C. of 15% or more, for example, 25% or more. Specifically, the adhesive film may have a shear strain at 60° C. of 15% to 50% or 25% to 50%. Within these range, the adhesive film can provide good foldability of a stack structure including the non-metal base material, the adhesive film, and the metal base material.

The adhesive film may have a storage modulus at −20° C. of 2 MPa or less, for example, 0.1 MPa to 1 MPa, specifically 0.1 MPa to 0.5 MPa, and a storage modulus at 60° C. of 0.5 MPa or less, for example, 0.01 MPa to 0.5 MPa, specifically 0.01 MPa to 0.1 MPa. Within these ranges, the adhesive film can provide good foldability while having enhanced adhesion to both the metal base material and the non-metal base material.

The adhesive film may be a (meth)acrylic adhesive film. In embodiments, the adhesive film may be a pressure sensitive adhesive (PSA) film.

According to embodiments, the adhesive film includes a cured product of a composition including a (meth)acrylic binder and a thermal curing agent. The (meth)acrylic binder is a (meth)acrylic copolymer of a monomer mixture including 1 wt % to 10 wt % of a cycloaliphatic group-containing (meth)acrylic monomer. The composition is a thermally curable composition. The adhesive film includes the thermally cured product, wherein the cycloaliphatic group-containing (meth)acrylic monomer is present in an amount of 1 wt % to 10 wt % in the monomer mixture. The adhesive film may thereby have enhanced peel strength with respect to both the non-metal base material and the metal base material under high temperature conditions and under high temperature and high humidity conditions while providing good foldability under high temperature and high humidity conditions.

If the content of the cycloaliphatic group-containing (meth)acrylic monomer in the monomer mixture is less than 1 wt %, the adhesive film may have poor foldability under high temperature and high humidity conditions due to reduction in peel strength with respect to the non-metal base material and the metal base material. If the content of the cycloaliphatic group-containing (meth)acrylic monomer in the monomer mixture exceeds 10 wt %, the adhesive film can have poor foldability under high temperature and high humidity conditions due to reduction in peel strength with respect to the non-metal base material and the metal base material and due to reduction in shear strain at 60° C.

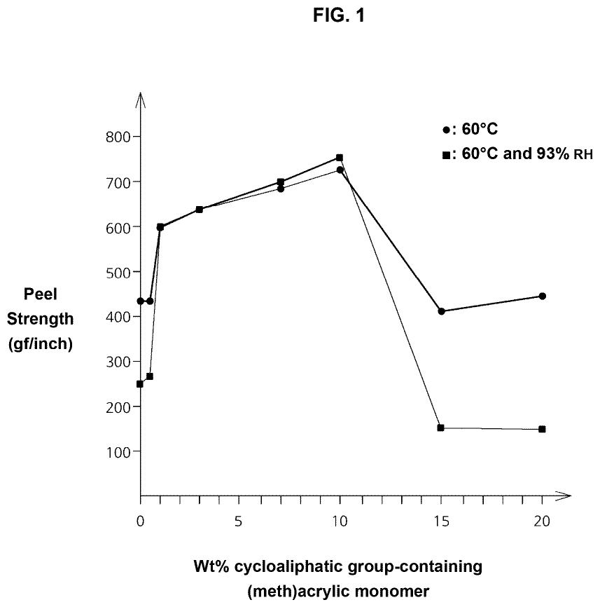

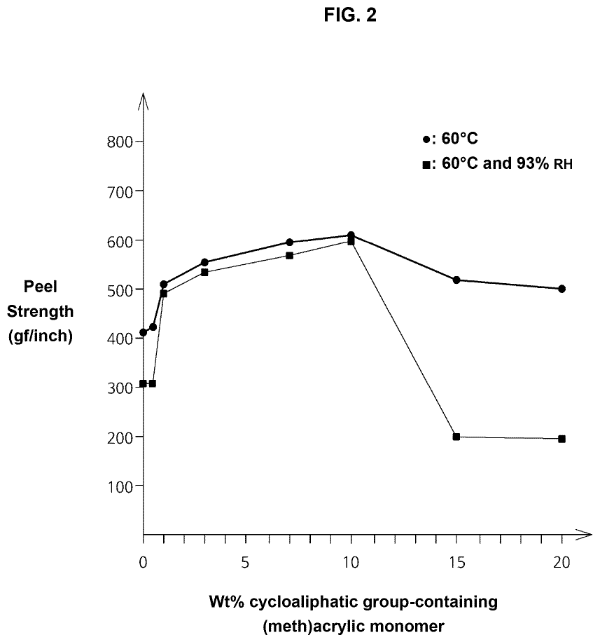

FIG. 1 is a graph depicting changes in peel strength of the adhesive film with respect to the non-metal base material under high temperature conditions and under high temperature and high humidity conditions as a function of the content of the cycloaliphatic group-containing (meth)acrylic monomer in the monomer mixture. FIG. 2 is a graph depicting changes in peel strength of the adhesive film with respect to the metal base material under high temperature conditions and high temperature and high humidity conditions as a function of the content of the cycloaliphatic group-containing (meth)acrylic monomer in the monomer mixture.

Referring to FIG. 1 and FIG. 2, it can be seen that the adhesive film has significantly high peel strength with respect to both the metal base material and the non-metal base material under high temperature conditions and high temperature and high humidity conditions when the content of the cycloaliphatic group-containing (meth)acrylic monomer in the monomer mixture is in the range of 1 wt % to 10 wt %.

FIG. 1 and FIG. 2 show the peel strength of the adhesive film according to the present disclosure with respect to the non-metal base material and the metal base material. In FIG. 1 and FIG. 2, the x-axis represents the wt % of the cycloaliphatic group-containing (meth)acrylic monomer in the monomer mixture, and the y-axis represents peel strength (gf/inch). In FIGS. 1 and 2, the circular data points “•” are the peel strength at 60° C., and the square data points “▪” are the peel strength at 60° C. and 93% RH.

The cycloaliphatic group-containing (meth)acrylic monomer may be a (meth)acrylic acid ester containing a C₅ to C₁₀ cycloaliphatic group at an ester site thereof (the cycloaliphatic group being a cyclic functional group consisting solely of carbon and hydrogen). For example, the (meth)acrylic acid ester may be at least one of cyclohexyl acrylate or cyclohexyl methacrylate, preferably cyclohexyl acrylate.

The monomer mixture may further include a (meth)acrylic monomer having a homopolymer glass transition temperature of −40° C. or less, for example, −80° C. to −40° C. The (meth)acrylic monomer having a homopolymer glass transition temperature in this range can reduce an increase in storage modulus of the adhesive film due to the cycloaliphatic group-containing (meth)acrylic monomer, thereby ensuring that the adhesive film maintains an appropriate level of storage modulus.

According to embodiments, the (meth)acrylic monomer having a homopolymer glass transition temperature of −40° C. or less may be a (meth)acrylic acid ester containing a linear or branched C₁ to C₂₀ alkyl group at an ester site thereof. Specifically, the (meth)acrylic acid ester may include at least one of a butyl (meth)acrylate, such as n-butyl (meth)acrylate; a pentyl (meth)acrylate, such as n-pentyl (meth)acrylate; a hexyl (meth)acrylate, such as n-hexyl (meth)acrylate; a heptyl (meth)acrylate, such as n-heptyl (meth)acrylate; an octyl (meth)acrylate, such as n-octyl (meth)acrylate; 2-ethylhexyl (meth)acrylate; a nonyl (meth)acrylate, such as n-nonyl (meth)acrylate; or a decyl (meth)acrylate, such as n-decyl (meth)acrylate.

The (meth)acrylic monomer having a homopolymer glass transition temperature of −40° C. or less may be present in an amount of 60 wt % to 90 wt %, for example, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90 wt %, or 60 wt % to 80 wt %, in the monomer mixture. Within these range, the (meth)acrylic monomer can ensure that the adhesive film maintains an appropriate level of storage modulus without reduction in peel strength of the adhesive film.

According to embodiments, the (meth)acrylic monomer having a homopolymer glass transition temperature of −40° C. or less may be a mixture of a linear C₁ to C₂₀ alkyl group-containing (meth)acrylic acid ester and a branched C₁ to C₂₀ alkyl group-containing (meth)acrylic acid ester. Each of the linear C₁ to C₂₀ alkyl group-containing (meth)acrylic acid ester and the branched C₁ to C₂₀ alkyl group-containing (meth)acrylic acid ester may be selected from among the C₁ to C₂₀ alkyl group-containing (meth)acrylic acid esters listed above. For example, the linear C₁ to C₂₀ alkyl group-containing (meth)acrylic acid ester may be n-propyl (meth)acrylate, n-butyl (meth)acrylate, or the like. The branched C₁ to C₂₀ alkyl group-containing (meth)acrylic acid ester may be 2-ethylhexyl (meth)acrylate or the like.

The linear C₁ to C₂₀ alkyl group-containing (meth)acrylic acid ester may be present in an amount of 10 wt % to 50 wt %, for example, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 wt %, or 10 wt % to 30 wt %, in the monomer mixture. The branched C₁ to C₂₀ alkyl group-containing (meth)acrylic acid ester may be present in an amount of 50 wt % to 90 wt %, for example, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90 wt %, or 50 wt % to 80 wt %, in the monomer mixture. Within these ranges, the linear C₁ to C₂₀ alkyl group-containing (meth)acrylic acid ester and the branched C₁ to C₂₀ alkyl group-containing (meth)acrylic acid ester can facilitate the desired effects of the adhesive film described herein.

The monomer mixture may further include a (meth)acrylic monomer containing a crosslinkable functional group. The (meth)acrylic monomer containing a crosslinkable functional group can enhance peel strength of the adhesive film. Here, the crosslinkable functional group may include at least one of a hydroxyl group, an amino group, an epoxy group, or a carboxylic acid group. Preferably, the crosslinkable functional group is a hydroxyl group, such that the (meth)acrylic monomer is a hydroxyl group-containing (meth)acrylic monomer.

The hydroxyl group-containing (meth)acrylic monomer may include at least one of a (meth)acrylic monomer containing a C₁ to C₂₀ alkyl group having a hydroxyl group, a (meth)acrylic monomer containing a C₃ to C₂₀ cycloalkyl group having a hydroxyl group, or a (meth)acrylic monomer containing a C₆ to C₂₀ aromatic group having a hydroxyl group. Specifically, the hydroxyl group-containing (meth)acrylic monomer may be a (meth)acrylic monomer containing a C₁ to C₂₀ alkyl group having a hydroxyl group and may include at least one of 2-hydroxyethyl (meth)acrylate, 2-hydroxypropyl (meth)acrylate, 2-hydroxybutyl (meth)acrylate, 4-hydroxybutyl (meth)acrylate, or 6-hydroxyhexyl (meth)acrylate. These compounds may be used alone or in mixtures thereof.

The hydroxyl group-containing (meth)acrylic monomer may be present in an amount of 5 wt % to 40 wt %, for example, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 wt %, or 5 wt % to 35 wt %, or 10 wt % to 35 wt %, in the monomer mixture. Within these ranges, the hydroxyl group-containing (meth)acrylic monomer can facilitate the desired effects of the adhesive film described herein.

According to one embodiment, the cycloaliphatic group-containing (meth)acrylic monomer, the (meth)acrylic monomer having a homopolymer glass transition temperature of −40° C. or less, and the hydroxyl group-containing (meth)acrylic monomer may be present in the monomer mixture, in total, in an amount of 98 wt % or more, for example, 99 wt % to 100 wt %, specifically 100 wt %. Within these ranges, the aforementioned (meth)acrylic monomers can facilitate the desired effects of the adhesive film described herein.

The (meth)acrylic binder may have a weight average molecular weight (Mw) of 500,000 g/mol to 2,000,000 g/mol, for example, 500,000, 600,000, 700,000, 800,000, 900,000, 1,000,000, 1,100,000, 1,200,000, 1,300,000, 1,400,000, 1,500,000, 1,600,000, 1,700,000, 1,800,000, 1,900,000, 2,000,000 g/mol, or 900,000 g/mol to 1,500,000 g/mol. Within these ranges, the (meth)acrylic binder can facilitate the desired effects of the adhesive film described herein.

The (meth)acrylic binder may have a glass transition temperature (Tg) of −35° C. or less, for example, −60, −59, −58, −57, −56, −55, −54, −53, −52, −51, −50, −49, −48, −47, −46, −45, −44, −43, −42, −41, −40, −39, −38, −37, −36, −35° C., or −60° C. to −35° C. Within these ranges, the (meth)acrylic binder can facilitate the desired effects of the adhesive film described herein.

In one embodiment, the (meth)acrylic binder may be prepared by polymerizing the monomer mixture by a common polymerization method. Here, the polymerization method may include any common polymerization method known in the art. For example, the (meth)acrylic binder may be prepared by adding an initiator to the monomer mixture, followed by a common copolymer polymerization process such as suspension polymerization, emulsion polymerization, solution polymerization, or the like. Polymerization of the monomer mixture may be carried out at a temperature of 65° C. to 70° C. for 6 to 8 hours. The initiator may be a common initiator, such as an azo polymerization initiator and/or a peroxide polymerization initiator, such as benzoyl peroxide or acetyl peroxide.

A thermal curing agent can facilitate formation of a matrix of the adhesive film while enhancing peel strength of the adhesive film by curing the (meth)acrylic binder.

The thermal curing agent may include at least one of an isocyanate curing agent, a metal chelate curing agent, an epoxy curing agent, an amine curing agent, or an aziridine curing agent.

The isocyanate curing agent may include a bifunctional to hexafunctional isocyanate curing agent. Specifically, the isocyanate curing agent may include an aromatic isocyanate curing agent including at least one of toluene diisocyanate, xylylene diisocyanate, halogen-substituted toluene diisocyanate, phenylene diisocyanate including m-phenylene diisocyanate and the like, or tetramethyl-xylylene diisocyanate; an aliphatic isocyanate curing agent including at least one of hexamethylene diisocyanate or pentamethylene diisocyanate; an cycloaliphatic isocyanate curing agent, such as cyclohexamethylene diisocyanate; or an adduct thereof, for example, a polyol (such as trimethylolpropane (TMP)) adduct of any of the aforementioned isocyanate curing agents.

The metal chelate curing agent is a crosslinking agent composed of a bond between a metal and a chelate, and may include a common metal chelate crosslinking agent known in the art. In one embodiment, the metal chelate crosslinking agent may include a crosslinking agent having at least two, for example, 3 to 6, metal-chelate bonds. For example, the metal may include aluminum, zirconium, titanium, or cobalt, preferably aluminum. For example, the chelate may include, without limitation, acetylacetonate, ethylacetoacetate, or the like. Specifically, the metal chelate crosslinking agent may include, without limitation, at least one of acetylacetonate aluminate, aluminum tris (acetylacetonate), aluminum tris (ethylacetoacetate), aluminum bis(acetoacetate), zirconium tris (acetylacetonate), or cobalt tris (acetylacetonate).

Preferably, the thermal curing agent is a mixture of the isocyanate curing agent and the metal chelate curing agent. Such a mixture can aid in ensuring that the composition including the (meth)acrylic binder described above provides the desired effects as described herein. In one embodiment, the isocyanate curing agent and the metal chelate curing agent may be present in a weight ratio of 1:0.1 to 1:3, for example, 1:0.1, 1:0.2, 1:0.3, 1:0.4, 1:0.5, 1:0.6, 1:0.7, 1:0.8, 1:0.9, 1:1.0, 1:1.1, 1:1.2, 1:1.3, 1:1.4, 1:1.5, 1:1.6, 1:1.7, 1:1.8, 1:1.9, 1:2.0, 1:2.1, 1:2.2, 1:2.3, 1:2.4, 1:2.5, 1:2.6, 1:2.7, 1:2.8, 1:2.9, 1:3, or 1:0.5 to 1:2, specifically 1:1 to 1:2. Within these ranges, the mixture can aid in ensuring that the composition including the (meth)acrylic binder provides the desired effects described herein.

The thermal curing agent may be present in an amount of 0.01 parts by weight to 1 part by weight, for example, 0.01 parts by weight to 0.5 parts by weight, specifically 0.01 parts by weight to 0.1 part by weight, relative to 100 parts by weight of the (meth)acrylic binder. Within these ranges, the adhesive film can easily satisfy the requirements related to peel strength, shear strain, and storage modulus.

The composition, that is, the adhesive film, may further include a silane coupling agent. The silane coupling agent can further enhance peel strength of the adhesive film. The silane coupling agent may include a common silane coupling agent known in the art. For example, the silane coupling agent may include an epoxy group-containing silane coupling agent, such as glycidoxypropyltrimethoxysilane, glycidoxypropylmethyldimethoxysilane, and the like. But the present disclosure is not limited thereto.

The silane coupling agent may be present in an amount of 0.01 parts by weight to 5 parts by weight, for example, 0.01 parts by weight to 0.1 part by weight, relative to 100 parts by weight of the (meth)acrylic binder. Within these range, the silane coupling agent can enhance peel strength of the adhesive film.

According to embodiments, the composition may be of a solvent-free type that does not contain any solvent.

According to other embodiments, the composition may further include a solvent. In manufacture of a thin adhesive film from the composition, the solvent allows the adhesive film to have an even surface. The solvent may be any common solvent known in the art without limitation. For example, the solvent may be an organic solvent, such as ethyl acetate, methyl ethyl ketone, methyl isobutyl ketone, and the like. The composition may have a solid content of 50 wt % or less, for example, 20 wt % or less.

The composition, that is, the adhesive film, may further include an additive. The additive can provide additional functionality to the adhesive film. The additive may include at least one of a UV absorber, a reaction inhibitor, an adhesion enhancer, a thixotropy-imparting agent, a conductivity-imparting agent, a color-adjusting agent, a stabilizer, an antioxidant, a leveling agent, or an antistatic agent. But the present disclosure is not limited to these examples. The content of the additive in the composition (adhesive film) may be appropriately adjusted without affecting the desired effects of the present disclosure.

The adhesive film may have a haze of 1% or less, for example, 0% to 1%, in the visible spectrum, for example, at a wavelength of 380 nm to 780 nm. Within these ranges, the adhesive film can be used in an optical display apparatus.

The adhesive film may have a thickness of 35 μm or less, for example, greater than 0 μm and less than or equal to 35 μm, specifically 5 μm to 15 μm. Within these ranges, the adhesive film can be used in an optical display apparatus.

According to one embodiment, the adhesive film may be free from organic nanoparticles. Here, “organic nanoparticles” may refer to organic nanoparticles known in the art to provide foldability, such as core-shell type nanoparticles. As an advantage of the present disclosure, the adhesive film provides good foldability despite being free from the organic nanoparticles.

The adhesive film may be formed from a composition as described above. Specifically, the adhesive film may be manufactured by applying the adhesive film forming composition to a release film, followed by thermal curing. Thermal curing of the adhesive film forming composition may be performed by heat treatment at a temperature of 80° C. to 100° C. for 1 to 30 minutes, but the present disclosure is not limited to heat treatment under such conditions.

In accordance with another aspect of the present disclosure, an optical member includes a stacked non-metal base material, an adhesive film, and a metal base material, wherein the adhesive film includes a cured product of a composition including a (meth)acrylic binder and a curing agent, and the (meth)acrylic binder is a (meth)acrylic binder of monomer mixture including 1 wt % to 10 wt % of a cycloaliphatic group-containing (meth)acrylic monomer.

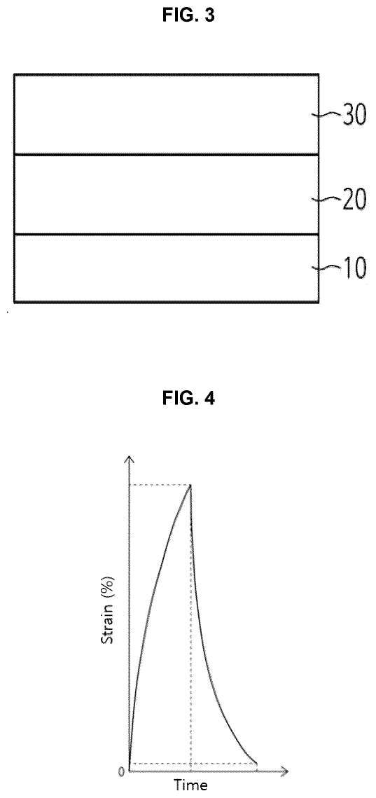

As shown in FIG. 3, an optical member may include a stacked non-metal base material 10, an adhesive film 20, and a metal base material 30. As the non-metal base material, the adhesive film, and the metal base material are substantially the same as those described above, detailed description thereof will be omitted.

In one embodiment, the optical member is used in an optical display apparatus to provide specific optical functions, such as polarization, optical compensation, display image enhancement, and/or conductivity. The optical member may include an optical film, such as a window film, a window, a polarizing plate, a color filter, a retardation film, an elliptically polarizing film, a reflective polarizing film, an antireflection film, a compensation film, a brightness enhancement film, an alignment film, a light diffusion film, an anti-shattering film, a surface protection film, a barrier film for OLEDs, a plastic LCD substrate, and a transparent electrode film including indium tin oxide (ITO), fluorinated tin oxide (FTO), aluminum-doped zinc oxide (AZO), carbon nanotubes (CNTs), Ag nanowires, graphene, and the like.

The optical member may have a three-layer structure of non-metal base material/adhesive film/metal base material. Alternatively, the optical member may include two or more layers of the non-metal base material, two or more layers of the adhesive film, and two or more layers of the metal base material.

In accordance with a further aspect of the present disclosure, an optical display apparatus includes the adhesive film described above or the optical member described above.

The optical display apparatus may include a light emitting diode display apparatus including an organic light emitting diode display apparatus and the like, a liquid crystal display apparatus, and the like. The optical display apparatus may include a flexible display apparatus. However, the present disclosure is not limited in this regard and the optical display apparatus may include a non-flexible display apparatus.

Next, the present disclosure will be described in more detail with reference to examples. The examples are provided for illustration only and are not limiting on the scope of the present disclosure.

### Example 1

In a 1 L reactor provided with a reflux cooler and a nitrogen inlet, 100 parts by weight of a monomer mixture including 2-ethylhexyl acrylate (2-EHA), n-butyl acrylate (n-BA), 4-hydroxybutyl acrylate (4-HBA), and cyclohexyl acrylate (CHA) were placed. Thereafter, 100 parts by weight of ethyl acetate as a solvent was added to the reactor. After the reactor was sufficiently purged with nitrogen gas to remove oxygen, the temperature of the reactor was maintained at 60° C. and 0.03 wt % of azobisisobutyronitrile as a polymerization initiator was added to the reactor. The reaction was allowed to proceed for 12 hours. Thereafter, the reaction product was diluted with ethyl acetate, thereby preparing a solution containing a (meth)acrylic binder that had a glass transition temperature: −54° C. and a weight average molecular weight of 1,200,000 g/mol.

Relative to 100 parts by weight of the (meth)acrylic binder in terms of solid content, 0.03 parts by weight of an isocyanate curing agent (Coronate-L, TOSOH Corporation), 0.03 parts by weight of a metal chelate curing agent (aluminum-containing trifunctional curing agent, CK-401E, NCI Chemicals), and 0.05 parts by weight of 3-glycidoxypropyltrimethoxysilane (KBM-403, Shin-Etsu Chemical Co., Ltd.) as a silane coupling agent were mixed with the prepared solution, thereby preparing an adhesive film composition that had a solid content of 20 wt %.

The prepared adhesive film composition was applied to a predetermined thickness to a polyethylene terephthalate (PET) film as a first release film, followed by drying, thereby obtaining a 15 μm thick coating film. Thereafter, the obtained coating film was covered by a PET film as a second release film, followed by drying (thermal curing) at 100° C. for 3 minutes, thereby making an adhesive sheet of first release film/adhesive film/second release film, with the adhesive film having a thickness of 15 μm.

### Examples 2 to 4

Adhesive sheets were made in the same manner as in Example 1 except that the content of each component of the adhesive film composition was changed as listed in Table 1.

### Comparative Examples 1 to 4

Adhesive sheets were made in the same manner as in Example 1 except that the content of each component of the adhesive film composition was changed as listed in Table 1.

The composition of each of the adhesive films of Examples 1 to 4 and Comparative Examples 1 to 4 is shown in Table 1. Each of the adhesive films of Examples 1 to 4 and Comparative Examples 1 to 4 was evaluated as to the following properties.

(1) Peel strength (gf/inch) with respect to PET film under high temperature conditions: Each of the adhesive sheets of Examples 1 to 4 and Comparative Examples 1 to 4 was cut to a size of 100 mm×25 mm (length×width). Thereafter, the first release film was removed from the adhesive sheet, followed by attachment of a non-corona-treated polyethylene terephthalate (PET) film to the adhesive film. The second release film was then removed from the adhesive film, followed by attachment of a corona-treated PET film to the adhesive film using a 2 kg hand roller, thereby preparing a specimen. Using the prepared specimen, peel strength of the stack of the adhesive film and the corona-treated PET film with respect to the non-corona-treated PET film was measured in a chamber at 60° C. under conditions of a peeling angle of 180° and a peeling rate of 300 mm/min. Measurement of peel strength was carried out using a TA.XT Plus texture analyzer (Stable Micro Systems, Inc.)

(2) Peel strength (gf/inch) with respect to PET film under high temperature and high humidity conditions: A specimen was prepared in the same manner as in (1). Peel strength was measured on the specimen in the same manner as in (1) in a chamber at 60° C. and 93% RH.

(3) Peel strength (gf/inch) with respect to metal plate under high temperature conditions: Each of the adhesive sheets of Examples 1 to 4 and Comparative Examples 1 to 4 was cut to a size of 100 mm×25 mm (length×width). Thereafter, the first release film was removed from the adhesive sheet, followed by attachment of a SUS metal plate to the exposed surface of the adhesive film. Then the second release film was removed from the adhesive film, followed by attachment of a non-corona-treated PET film to the adhesive film using a 2 kg hand roller, thereby preparing a specimen. Using the prepared specimen, peel strength of the stack of the adhesive film and the non-corona-treated PET film with respect to the SUS metal plate was measured in the same manner as in (1).

(4) Peel strength (gf/inch) with respect to metal plate under high temperature and high humidity conditions: A specimen was prepared in the same manner as in (3). Peel strength was measured on the specimen in the same manner as in (3) in a chamber at 60° C. and 93% RH.

(5) Shear strain %: The first and second release films were removed from each of the adhesive sheets of Examples 1 to 4 and Comparative Examples 1 to 4, thereby obtaining an adhesive film (100 mm×25 mm (length×width)). A plurality of such adhesive films was formed into a stack, which, in turn, was perforated using a perforator with a diameter of 8 mm, thereby preparing a cylindrical specimen (thickness: 500 μm, diameter: 8 mm) having an upper surface and a lower surface.

The prepared cylindrical specimen was mounted on a dynamic viscoelasticity measuring instrument (Rheometer DHR3, TA Instruments Inc.) with the upper and lower surfaces thereof clamped in upper and lower jigs of the dynamic shear rheometer, respectively. Strain of the specimen was measured with a chamber temperature of 60° C., an axial force of 1 N, a torque of 2 kPa, a stress application period of 600 seconds, and a stress release period of 600 seconds. A strain at a stress time of 600 seconds was defined as shear strain.

(6) Storage modulus (MPa): Using a dynamic viscoelasticity measuring instrument (Rheometer DHR3, TA Instruments Inc.), storage modulus was measured in auto-strain mode under conditions of a shear rate of 1 rad/sec and a strain of 1%. After an adhesive film was obtained from each of the adhesive sheets of Examples 1 to 4 and Comparative Examples 1 to 4, a plurality of such adhesive films was formed into a stack having a thickness of 500 μm. Thereafter, the stack was perforated using a perforator with a diameter of 8 mm, thereby preparing a specimen. Storage modulus of the specimen was measured in a temperature sweep test mode by heating the specimen from −50° C. to 100° C. at a heating rate of 5° C./min while applying a normal force of 1.0 N to the specimen using an 8 mm jig, thereby obtaining storage modulus at −20° C. and 60° C.

(7) Foldability: An adhesive film was obtained by removing the first and second release films from each of the adhesive sheets of Examples 1 to 4 and Comparative Examples 1 to 4. Each adhesive film was attached to a 50 μm thick corona-treated PET film and a SUS metal plate using a roller with one surface thereof adjoining a corona-treated surface of the PET film and the other surface thereof adjoining the SUS metal plate, followed by ageing at room temperature for 12 hours, and then was cut to a size of 70 mm×140 mm (width×length), thereby preparing a specimen. The prepared specimen was secured to a folding tester (CFT-200, Covotech Co., Ltd.) using an adhesive (4965, Tesa Tapes Inc.), followed by repeating the procedure of bending the long side (140 mm) of the specimen to a radius of curvature of 3 mm at a rate of 30 cycles per minute at 60° C. and 93% RH (one cycle being defined as folding the adhesive film in half and unfolding the adhesive film back to an original state thereof once). A minimum number of bending cycles at which cracking of the adhesive film was observed with the naked eye was measured. A greater minimum number of bending cycles indicates that a corresponding adhesive film is more effective at relaxing bending-induced stress of the PET film and the SUS metal plate. When the minimum number of bending cycles was 100,000 or more, a corresponding adhesive film was rated as “OK”. When the minimum number of bending cycles was less than 100,000, a corresponding adhesive film was rated as “NG”. Measurement of foldability was performed at 60° C. and 93% RH.

TABLE 1

| | | | Example | | | | Comparative Example | | | |
|---|---|---|---|---|---|---|---|---|---|---|
| | | | 1 | 2 | 3 | 4 | 1 | 2 | 3 | 4 |
| (Meth)acrylic | 2-EHA | | 58 | 56 | 54 | 59 | 60 | 51 | 48 | 59.5 |
| binder | n-BA | | 15 | 14 | 13 | 15 | 15 | 13 | 12 | 15 |
| | 4-HBA | | 24 | 23 | 23 | 25 | 25 | 21 | 20 | 25 |
| | CHA | | 3 | 7 | 10 | 1 | 0 | 15 | 20 | 0.5 |
| | Tg | | −54 | −52 | −50 | −54 | −52 | 48 | 45 | -54 |
| | Mw | | 1,200,000 | 1,200,000 | 1,200,000 | 1,200,000 | 1,200,000 | 1,200,000 | 1,200,000 | 1,200,000 |
| Curing agent | Isocyanate | | 0.03 | 0.03 | 0.03 | 0.03 | 0.03 | 0.03 | 0.03 | 0.03 |
| | Metal Chelate | | 0.03 | 0.03 | 0.03 | 0.03 | 0.03 | 0.03 | 0.03 | 0.03 |
| Silane coupling agent | | | 0.05 | 0.05 | 0.05 | 0.05 | 0.05 | 0.05 | 0.05 | 0.05 |
| Thickness (μm) | | | 15 | 15 | 15 | 15 | 15 | 15 | 15 | 15 |
| Peel strength | PET film | @60° C. | 634 | 680 | 720 | 598 | 430 | 410 | 440 | 430 |
| | | @60° C./93 | 634 | 690 | 750 | 600 | 250 | 160 | 150 | 270 |
| | | % RH | | | | | | | | |
| Peel strength | Metal plate | @60° C. | 560 | 590 | 610 | 510 | 420 | 520 | 500 | 430 |
| | | @60° C./93 | 540 | 570 | 600 | 490 | 310 | 200 | 190 | 310 |
| | | % RH | | | | | | | | |
| Shear strain | | | 30 | 29 | 28 | 31 | 21 | 18 | 15 | 22 |
| Storage modulus | | @−20° C. | 0.12 | 0.14 | 0.15 | 0.12 | 0.11 | 0.56 | 1.01 | 0.11 |
| | | @60° C. | 0.03 | 0.03 | 0.03 | 0.03 | 0.03 | 0.04 | 0.05 | 0.03 |

| | | | | | | | | |
|---|---|---|---|---|---|---|---|---|
| Foldability under high temperature | OK | OK | OK | OK | NG | NG | NG | NG |
| and high humidity conditions | | | | | | | | |

As can be seen from Table 1, the adhesive film according to the present disclosure exhibited high peel strength with respect to both the non-metal base material and the metal base material under high temperature conditions and high temperature and high humidity conditions. Also, the adhesive film could ensure good foldability of a stack structure of the non-metal base material, the adhesive film, and the metal base material.

Conversely, the adhesive films of Comparative Examples 1 to 4 failed to provide the combination of desired effects as described herein.

It should be understood that various modifications, changes, alterations, and equivalent embodiments can be made by those skilled in the art without departing from the spirit and scope of the present disclosure.

What is claimed is:

1. An adhesive film for adhering a non-metal base material and a metal base material, the adhesive film comprising:
a cured product of a composition including (meth)acrylic binder and a thermal curing agent,
wherein the adhesive film has a peel strength at 60° C. and 93% relative humidity of 400 gf/inch or more with respect to each of the non-metal base material and the metal base material, and
wherein the (meth)acrylic binder is formed from a monomer mixture comprising 1 wt % to 10 wt % of a cycloaliphatic group-containing (meth)acrylic monomer.

2. The adhesive film as claimed in claim 1, wherein the adhesive film has a shear strain of 15% or more at 60° C.

3. The adhesive film as claim in claim 1, wherein the adhesive film has a storage modulus of 2 MPa or less at −20° C. and a storage modulus of 0.5 MPa or less at 60° C.

4. The adhesive film as claimed in claim 1, wherein the adhesive film has a value of 1 or more, as calculated according to an Equation A2/A1, where A1 is a peel strength in gf/inch of the adhesive film with respect to the non-metal base material at 60° C. and where A2 is a peel strength (unit: gf/inch) of the adhesive film with respect to the non-metal base material at 60° C. and 93% RH, and
wherein the adhesive film has and a value of 1 or more as calculated according to Equation B1/B2 where B1 is a peel strength in gf/inch of the adhesive film with respect to the metal base material at 60° C. and where B2 is a peel strength in gf/inch of the adhesive film with respect to the metal base material at 60° C. and 93% RH.

5. The adhesive film as claimed in claim 1, wherein the cycloaliphatic group-containing (meth)acrylic monomer comprises at least one of cyclohexyl acrylate or cyclohexyl methacrylate.

6. The adhesive film as claimed in claim 1, wherein the monomer mixture further comprises a (meth)acrylic monomer having a homopolymer glass transition temperature of −40° C. or less.

7. The adhesive film as claimed in claim 6, wherein the (meth)acrylic monomer having a homopolymer glass transition temperature of −40° C. or less is a (meth)acrylic acid ester containing a linear or branched C₁ to C₂₀ alkyl group at an ester site of the (meth)acrylic acid ester.

8. The adhesive film as claimed in claim 6, wherein the (meth)acrylic monomer having a homopolymer glass transition temperature of −40° C. or less is present in an amount of 60 wt % to 90 wt % in the monomer mixture.

9. The adhesive film as claimed in claim 6, wherein the monomer mixture further comprises a hydroxyl group-containing (meth)acrylic monomer.

10. The adhesive film as claimed in claim 9, wherein the cycloaliphatic group-containing (meth)acrylic monomer, the (meth)acrylic monomer having a homopolymer glass transition temperature of −40° C. or less, and the hydroxyl group-containing (meth)acrylic monomer are present, in total, in an amount of 98 wt % or more in the monomer mixture.

11. The adhesive film as claimed in claim 1, wherein the thermal curing agent is a mixture of an isocyanate curing agent and a metal chelate curing agent.

12. An optical member comprising:
a non-metal base material;
an adhesive film; and
a metal base material,
wherein the adhesive film adheres the non-metal base material to the metal base material, and
wherein the adhesive film comprises a cured product of a composition comprising a (meth)acrylic binder and a thermal curing agent, the (meth)acrylic binder being formed from a monomer mixture comprising 1 wt % to 10 wt % of a cycloaliphatic group-containing (meth)acrylic monomer.

13. The optical member as claimed in claim 12, wherein the non-metal base material is a polymer film.

14. The optical member as claimed in claim 12, wherein the adhesive film has a shear strain of 15% or more at 60° C.

15. The optical member as claimed in claim 12, wherein the adhesive film has a storage modulus of 2 MPa or less at −20° C. and a storage modulus of 0.5 MPa or less at 60° C.

16. The optical member as claimed in claim 12, wherein the monomer mixture further comprises a (meth)acrylic monomer having a homopolymer glass transition temperature of −40° C. or less.

17. The optical member as claimed in claim 16, wherein the (meth)acrylic monomer having a homopolymer glass transition temperature of −40° C. or less is present in an amount of 60 wt % to 90 wt % in the monomer mixture.

18. The optical member as claimed in claim 17, wherein the monomer mixture further comprises a hydroxyl group-containing (meth)acrylic monomer.

19. The optical member as claimed in claim 18, wherein the cycloaliphatic group-containing (meth)acrylic monomer, the (meth)acrylic monomer having a homopolymer glass transition temperature of −40° C. or less, and the hydroxyl group-containing (meth)acrylic monomer are present, in total, in an amount of 98 wt % or more in the monomer mixture.

20. An optical display apparatus comprising the adhesive film as claimed in claim 1.

21. An optical display apparatus comprising the optical member as claimed in claim 12.
